(19) United States
(12) Patent Application Publication
(10) Pub. No.: US 2002/0047258 A1
(43) Pub. Date: Apr. 25, 2002

(54) PORTFOLIOS WITH ENHANCED MOLDED COVERS

(75) Inventor: THOMAS M. WIEN, NEWPORT BEACH, CA (US)

Correspondence Address: ERIC K SATERMO, PO BOX 19099, IRVINE, CA, 926239099

(73) Assignee: wien

(21) Appl. No.: 09/395,907

(22) Filed: Sep. 11, 1999

(51) Int. Cl. B42D 3/00

(52) U.S. Cl. 281/36

(57) ABSTRACT

A portfolio includes a cover with a body. The body has a front, a spine, a back, and a pair of hinges. The body is made from moldable material that is molded to form integrally the front, the spine, the back, and the hinges. The moldable material of the body provides support to the portfolio and may be resilient to absorb shock. The body of the cover may include a plurality of features projecting from an outer side thereof. A number of such features may be disposed along the spine to provide a grip-like surface. The body may also be molded to include one or more accessory features or logo features. Stiffening structure may be provided to increase the rigidity of the cover, and a skin may be provided on an outer side of the body. The body, including the bonding of the skin to the body, may be formed in one step of a manufacturing process.

### BACKGROUND OF THE INVENTION

1. Field of the Invention

The present invention relates to portfolios such as binders and organizers. The present invention also relates to covers for portfolios and to methods for forming such covers.

2. Description of the Related Art

Portfolios are useful in organizing papers and associated stationery supplies. In the recent past, portfolios were bound in leather and were essentially used exclusively by professionals who could afford to purchase one. However, in recent years, portfolios are being bound in newer, less expensive materials such as nylon, thereby reducing prices and increasing the availability to a larger market.

Portfolios often include a three-ring binder housed within a cover which typically has a zipper. The cover provides support for the portfolio and protection for the contents. To provide this support, a sheet of paperboard is incorporated within each section of the cover, that is, the front, the back, and the spine. A layer of nylon fabric is sewn to both sides of the sheets of paperboard to hold the cover together.

One of the drawbacks of conventional portfolios is a lack of durability and sturdiness. For example, although flexible, the paperboard support sheets can become bent and fatigued over time, thereby reducing their strength and rigidity. In addition, the support sheets lacks resiliency and are, therefore, unable inherently to absorb any kind of shock. Other types of support sheets, such as sheets of plastic, also suffer from these drawbacks. In addition, because the support sheets are three separate articles, the cover lacks an integral support structure and is generally flimsy and easily crumpled.

As mentioned, the market for portfolios has grown in recent times due to the reduction of price and the incorporation of new materials. Many of these materials are appealing to a younger market, such as a market of consumers in high school and college. Accordingly, many manufacturers have increased the marketability of their products by enhancing the design and features of the portfolios. However, conventional designs are limited to the layer of nylon fabric covering the support sheet.

In view of the foregoing, there remains a need in the art for strong, durable, and resilient, portfolios with tactile appeal-enhancing features.

### BRIEF SUMMARY OF THE INVENTION

The present invention provides portfolios that incorporate a novel and enhanced cover. The enhanced cover includes a body with a front, a spine, a back, and a pair of hinges. The body is made from moldable material that is molded to form integrally the front, the spine, the back, and the hinges. The single-piece integral body of the cover provides substantial support and reduces flimsiness. Moreover, the single-piece integral body is also easily formed in a single manufacturing step, which is discussed below.

In addition to the integral body structure of the cover, the moldable material of the body also provides rigidity to the cover, thereby providing support to the portfolio. Further, the moldable material may also be resilient, which not only provides shock-absorbing characteristics for the cover but also enhances the tactile feel of the cover.

Complementing these advantages of resiliency and tactility of the moldable material, the body of the cover may be configured in any desired manner. For example, the body may include a plurality of features that project therefrom. These features may be aesthetically designed to increase the visual appeal of the portfolio, and may also be configured to increase the tactility of the cover. For example, a plurality of features may be disposed along the spine to provide a grip-like surface that is appealing to hold.

In addition to the projecting features, the body may be molded to include an accessory holder or a logo feature. More specifically, the body may be molded to include a recess for receiving an accessory such as a pen or pencil and/or a recess for receiving an ensign with a logo. Because of the recessed nature of these features, the accessory and/or the ensign are substantially flush with the outer surface of the cover.

Although the molded material of the body provides support for the portfolio, the overall rigidity of the cover may be enhanced with the provision of stiffening structure. In addition, although the body of the cover may be exposed, an outer skin may be provided on the body. The skin not only offers protection to the body but also increases the design possibilities of the cover.

According to methodology of the invention, the body of the cover may be formed in a single step by pressing a piece of moldable material in a mold to form integrally the front, the spine, the back, and the hinges of the body. The skin may be bonded to the body also in this single step.

Other aspects, features, and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of a portfolio with a molded cover in accordance with an exemplary embodiment of the present invention, particularly illustrating a portion of the cover partially cut-away to show a body of the cover;

FIG. 2 is a plan view of a cover of an exemplary portfolio of the invention, particularly illustrating an outside of the cover;

FIG. 3 is a plan view of a cover of an exemplary portfolio of the invention, particularly illustrating an inside of the cover;

FIG. 4 is a cross-sectional view of an exemplary cover of the invention taken along line 4-4 of FIG. 2, particularly illustrating a molded body of the cover;

FIG. 5 is an enlarged fragmentary cross-sectional view of an exemplary cover of the invention;

FIG. 6 is a cross-sectional view of an exemplary cover of the invention taken along line 6-6 of FIG. 2, particularly illustrating an accessory holder of the cover;

FIG. 7 is a cross-sectional view of an exemplary cover of the invention taken along line 7-7 of FIG. 2, particularly illustrating a logo feature of the cover;

FIG. 8 is a schematic view of an exemplary mold for forming a body of the cover of the present invention; and

FIG. 9 is a fragmentary side plan view of an exemplary molded cover of the present invention, particularly illustrating a finger grip-like spine of the cover.

### DETAILED DESCRIPTION OF THE INVENTION

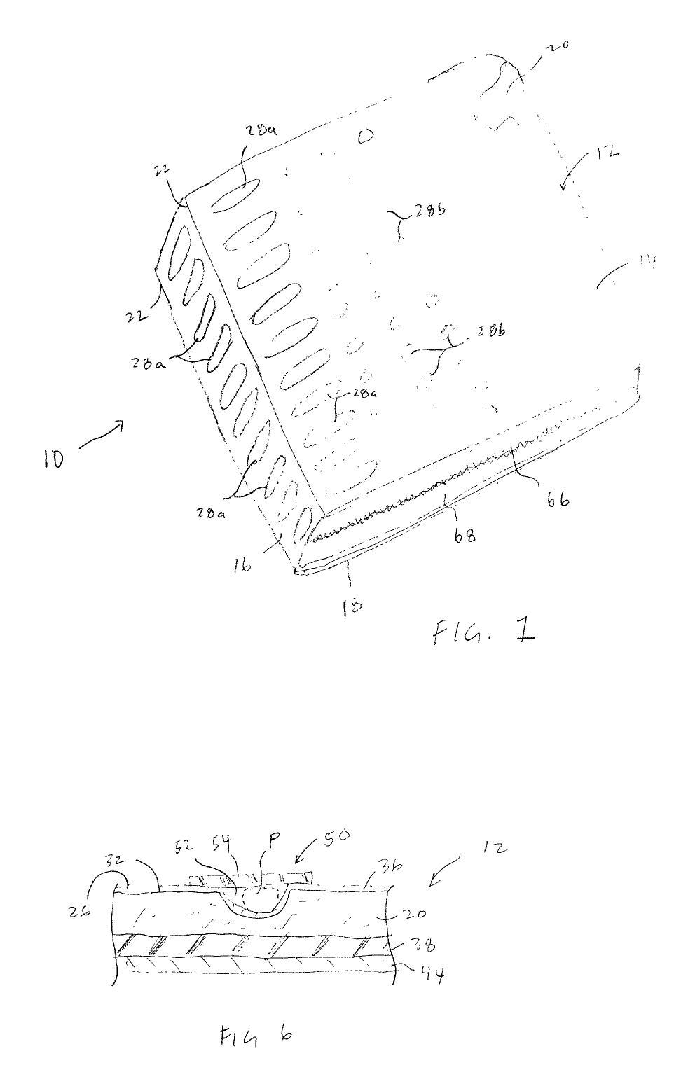

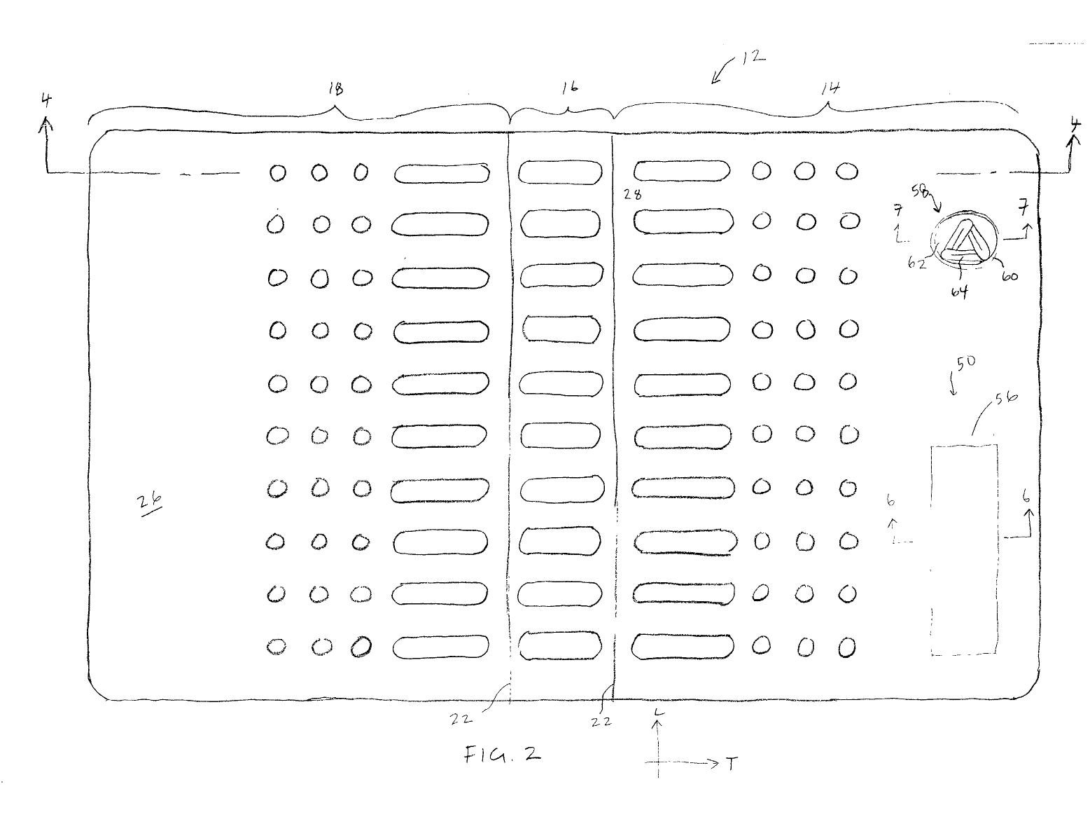

Referring more particularly to the drawings, a portfolio 10 configured in accordance with the present invention is shown in FIGS. 1, 2, and 3. Exemplary portfolio 10 generally includes a cover 12 with a front 14, a spine 16, and a back 18. Exemplary cover 12 has a body 20 that either includes or is made from moldable material. Exemplary body 20 is formed or molded to define the front 14, the spine 16, and the back 18, which is discussed in more detail below. In addition, exemplary cover 12 includes a pair of hinges 22 respectively formed between the spine 16 and the front 14 and between the spine 16 and the back 18, and has an inner side 24 and an outer side 26. For the purposes of this description, each portion of the cover 12 (i.e., the front 14, the spine 16, and the back 18) has a longitudinal axis and a transverse axis, which axes are respectively indicated by alphas L and T in FIG. 2.

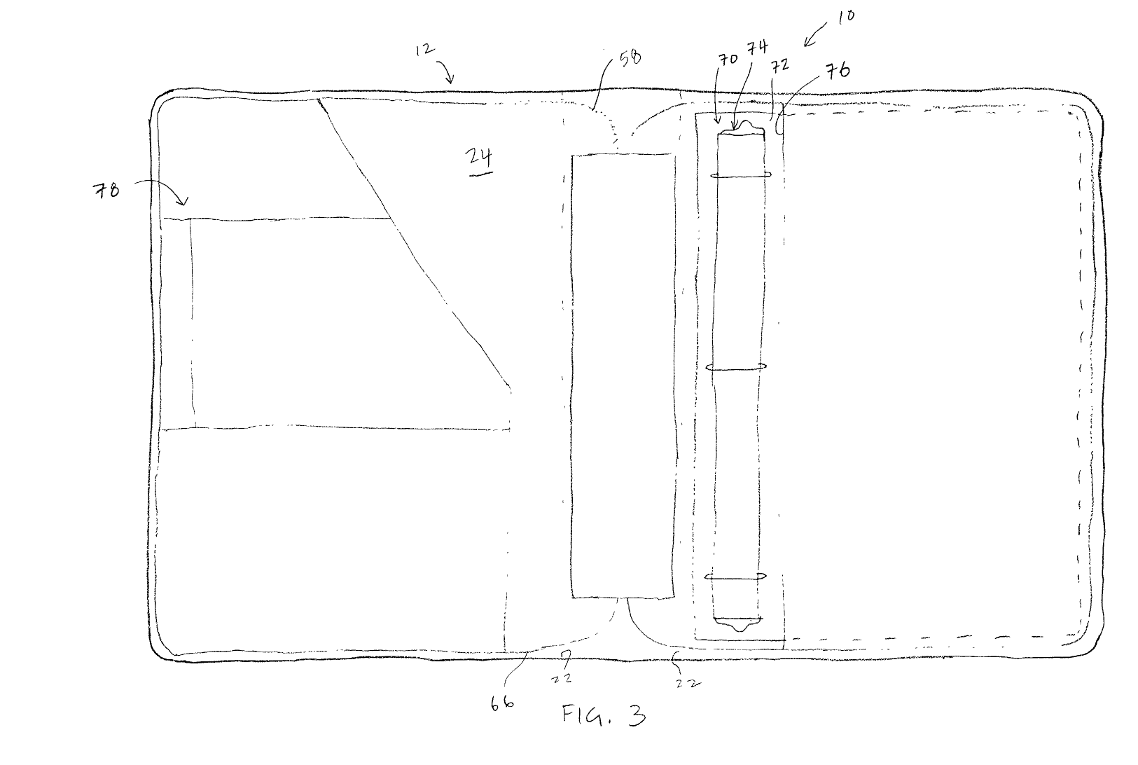

With additional reference to FIG. 4, exemplary body 20 is formed or molded to include at least one but preferably a plurality of features 28 disposed on at least one side thereof, which are discussed in detail below. In addition, the body 20 of the cover 12 is preferably formed from a single piece of moldable material, thereby yielding an integral body including the front 14, the spine 16, and the back 18. The molded material of the body 20 may also be elastic or resilient. Accordingly, in such an embodiment the body 20 is able to absorb shock, thereby offering added protection to the contents of the portfolio 10. In addition, the resiliency of the moldable material of the body 20 enhances the overall tactility of the portfolio 10. The moldable material of the body 20 is preferably flexible and resilient while retaining a certain degree of rigidity for support and protection. An example of such a moldable material is ethyl vinyl acetate (EVA).

Turning to the surface of exemplary cover 12, the features 28 of the present invention preferably project outward from the outer side 26 of the cover 12, thereby providing a tactile and textured surface. The plurality of features 28 may include features of different size and shape. For example, one or more of the features 28 may be substantially oblong in shape, which oblong features are indicated by reference numeral 28a, and one or more of the features may be substantially circular or hemispherical in shape, which circular features are indicated by reference numeral 28b.

The plurality of features 28 may be disposed in any desired arrangement on the front 14, the spine 16, and the back 18 of the cover 12. For example, a plurality of exemplary oblong features 28a may be transversely disposed and longitudinally aligned along the spine 16, thereby providing a tactile finger grip-like structure to the spine. In addition, a plurality of exemplary oblong features 28a may be transversely disposed and longitudinally aligned on the front 14 and the back 18 near the hinges 22. For aesthetic effect, the oblong features 28a disposed on the spine 16 may be transversely aligned with corresponding oblong features 28a of the front 14 and the back 18 of the cover 12. Furthermore, exemplary circular features 28b may be arranged in a matrix-like pattern on the front 14 and the back 18 and, for aesthetic effect, transversely aligned with a corresponding oblong feature 28a.

With particular reference to FIG. 4, exemplary hinges 22 may be formed by channels 30 longitudinally disposed in the body 20, for example, expansion channels 30a formed in an outer side 32 of the body and compression channels 30b formed in an inner side 34 of the body. Exemplary expansion channels 30a expand while exemplary compression channels 30b compress to facilitate the pivoting motion of the front 14 and the back 18 with respect to the spine 16, as shown by arrows A. As the hinges 22 are integral with the spine 16 and the front 14 and the back 18, the hinges 22 essentially function as living hinges. The channels 30 may be formed by, for example, molding (e.g., simultaneously when forming the body 20 with the features 28) or routing. Rather than a single expansion channel 30a (or compression channel 30b) as shown in FIG. 4, each of the hinges 22 may be provided with a plurality of expansion channels 30a as illustrated in FIG. 5.

Referencing FIG. 5, the cover 12 of the present invention may include a skin 36 disposed on at least one side of the body 20. For example, exemplary skin 36 may be disposed on the outer side 32 of the body 20, thereby defining the outer side 26 of the cover 12. The skin 36 may be fixed to the body 20 by, for example, adhesive or bonding, or by other means known in the art. Preferably, exemplary skin 36 is bonded or fixed during the molding process in forming the body 20. The skin 36 of the present invention may be nylon, microfiber, polyester, or other petrochemical material as known in the art. The skin 36 may also be made from a natural-fiber material, such as cotton or linen, or an animal skin such as leather.

Although the moldable material of the body 20 has a certain degree of rigidity, in many embodiments of the invention it may be desirable to enhance the rigidity. To do so, exemplary cover 12 may include stiffening structure, such as a front stiffener 38, a spine stiffener 40, and a back stiffener 42. Each of the stiffeners 38-42 is disposed adjacent to and substantially coplanar with the inner surface 24 of the front 14, the spine 16, and the back 18, respectively. The stiffeners 38-42 may be made from, for example, plastic material, pressboard material, or other strong but flexible material as known in the art.

With continued reference to FIG. 5, exemplary cover 12 may include an inner layer of material, which is indicated by reference numeral 44. One of the functions of exemplary inner layer 44 is to assist in retaining the stiffeners 38-42 in place. Accordingly, a sandwich structure is defined by the body 20, the skin 36, the stiffeners 38-42, and the inner layer 44. To assemble, this sandwich layer may be sewn together around the periphery of the cover, which sewing is indicated by reference numeral 46 in FIG. 5. A peripheral border 48 may be provided to enhance the integrity of the sewing 46 and to enhance the aesthetics of the cover 12. As shown in FIG. 5, the stiffeners 38-42 may be positioned with respect to the body 20 so that the sewing 46 does not pierce the body 20 but rather extends through the skin 36, the stiffeners 38-42, the inner layer 44, and the border 46.

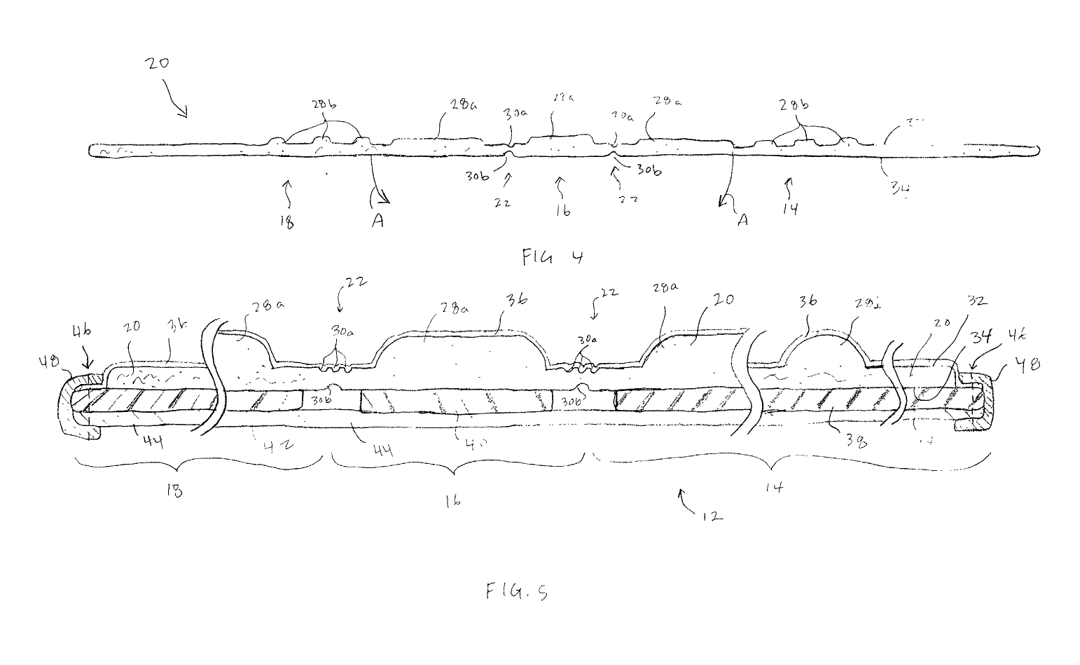

With further reference to FIG. 2 and additional reference to FIG. 6, exemplary cover 12 may include an accessory holder 50 in addition to the textured tactile features 28. Exemplary accessory holder 50 includes a debossed recess 52 formed in the outer side 32 of the body 20. The accessory holder 50 may also include a retaining strip 54 which forms with the recess 52 a pocket with an opening 56. The accessory holder 50 of the present invention may be configured to retain any type of article. In the example shown in the drawings, the accessory holder 50 is configured to hold a pen or a pencil. The accessory holder 50 may be configured such that when an accessory such as a pencil P is received within the holder 50, the accessory is substantially flush with the outer side 26 of the cover 12.

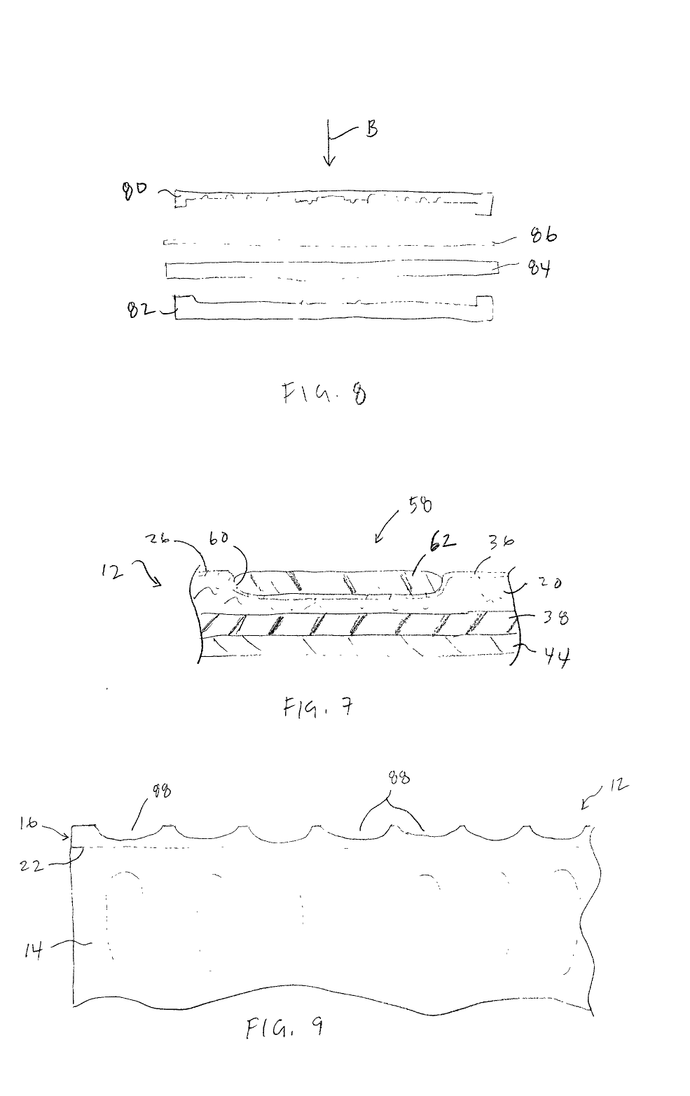

With continued reference to FIG. 2 and additional reference to FIG. 7, exemplary cover 12 may also include a logo feature 58. Exemplary logo feature 58 includes a debossed recess 60 formed in the outer side 32 of the body 20. An ensign 62 with a logo 64 is received and fixed within the recess 60. Those skilled in the art will appreciate that the logo feature 58 of the present invention may be configured in any desired shape or size. Although not necessary, to enhance the aesthetics of the logo feature 58, the recess 60 and the ensign 62 may be configured so that a top surface of the ensign is substantially flush with the outer side 26 of the cover 12.

In addition to the accessory holder 50 and the logo feature 58, the portfolio 10 of the present invention may include a number of other features. For example, with reference to FIGS. 1 and 3, the portfolio 10 may include a peripheral zipper 66 attached to the periphery of the cover 12 with suitable material 68 by, for example, the sewing 46. In addition, exemplary portfolio 10 may incorporate a half binder 70 including a support piece 72 and a ring assembly 74, with the support piece being receivable within a pocket 76. Alternatively, a ring binder assembly may be attached along the spine 16. Other sleeves and pockets, generally indicated by reference numeral 78, may also be provided as known in the art.

As mentioned above, in manufacturing the cover 12 of the present invention, particularly exemplary body 20, a single piece of moldable material is pressed into the desired shape and configuration of the body. With reference to FIG. 7, this process may be carried out with a mold, including a top press 80 and a bottom press 82. Either of the presses, for example, the top press 80, has a surface in negative relief to the desired outer side 32 of the body 20. Correspondingly, the other press has a surface in negative relief to the desired inner side 34 of the body 20.

A piece of moldable material 84 is placed between the presses 80 and 82, and the presses are brought together, as indicated by arrow B, thereby yielding the body 20. In addition, a piece of bondable material 86 may also be provided on one side of the moldable material 84 between the moldable material 84 and the top press 80 to yield the skin 36 bonded to the outer side 32 of the body 20. The bonding of material 86 to the body 20 may be accomplished with heat and/or pressure. In addition, adhesive (not shown) may be provided to bond material 86 to the body 20.

Although the figures illustrate specific exemplary configurations of the features 28, as well as an exemplary arrangement of the features 28 on the cover 12, those skilled in the art will appreciate that any number of variations and modifications of the configurations of the features 28 and that any number of arrangements of the features 28, are possible and within the scope of the present invention. For example, as shown in FIG. 9, rather than providing a plurality of projecting features 28b along the spine 16, a plurality of depressions 88 may be formed transversely in the body of the spine 16, thereby providing a finger grip-like structure. The depressions 88 are preferably semi-circular in shape to conform to and complement the shape of human fingers, which is particularly shown in the side plan view of FIG. 9. Additionally, the depressions 88 are preferably spaced longitudinally along the spine 16 to complement the spacing of human fingers.

Those skilled in the art will also understand that the preceding exemplary embodiments of the present invention provide the foundation for numerous alternatives and modifications thereto. These other modifications are also within the scope of the present invention. Accordingly, the present invention is not limited to that precisely as shown and described above but by the scope of the appended claims.

What is claimed is:

1. A cover for a portfolio, said cover comprising:
a body including a front, a spine, a back, and a pair of hinges respectively disposed between said spine and said front and between said spine and said back;
said body including moldable material molded to form integrally said front, said spine, said back, and said hinges.

2. A cover as claimed in claim 1 wherein said moldable material is resilient.

3. A cover as claimed in claim 1 wherein said body includes a plurality of features projecting therefrom.

4. A cover as claimed in claim 1 wherein said body includes a plurality of features disposed on said spine.

5. A cover as claimed in claim 4 wherein said plurality of features includes features that are disposed substantially transversely on said spine.

6. A cover as claimed in claim 4 wherein said plurality of features includes a plurality of depressions disposed substantially transversely in a longitudinally spaced relationship.

7. A cover as claimed in claim 1 wherein said body includes a recess formed therein for receiving an accessory.

8. A cover as claimed in claim 1 wherein said body includes a recess formed therein for receiving an ensign.

9. A cover as claimed in claim 1 wherein each said hinge includes at least one channel formed longitudinally along said spine.

10. A cover as claimed in claim 1 further comprising stiffening structure.

11. A cover as claimed in claim 1 further comprising:
a skin attached to said body.

12. A cover as claimed in claim 11 wherein said skin is bonded to said body.

13. A cover as claimed in claim 11 wherein said skin is attached to an outer side of said body.

14. A portfolio comprising:
a cover including a body having a front, a spine, a back, and a pair of hinges respectively disposed between said spine and said front and between said spine and said back;
said body including moldable material molded to form integrally said front, said spine, said back, and said hinges.

15. A portfolio as claimed in claim 14 wherein said cover includes a skin attached to an outer side of said body.

16. A portfolio as claimed in claim 15 wherein said body includes a plurality of features projecting from said outer side thereof, thereby providing said cover with a textured surface.

17. A portfolio as claimed in claim 14 further comprising a zipper.

18. A portfolio as claimed in claim 14 further comprising a half binder.

19. A method for forming a cover for a portfolio, said cover including a body having a front, a spine, a back, and a pair of hinges respectively disposed between said spine and said front and between said spine and said back, said method comprising the steps of:
providing a piece of moldable material; and
pressing said piece of moldable material in a mold to form integrally the front, the spine, the back, and the hinges of the body.

20. A method as claimed in claim 19 further comprising the steps of:
providing a piece of bondable material; and
positioning said piece of bondable material on one side of said piece of moldable material;
wherein said pressing step comprises the step of pressing said piece of moldable material and said piece of bondable material in a mold to form integrally the front, the spine, the back, and the hinges of the body.
